(19) United States
(12) Patent Application Publication
(10) Pub. No.: US 2013/0256354 A1
(43) Pub. Date: Oct. 3, 2013

(54) SECURE HANGER

(71) Applicants: Michael Dane Clark, San Diego, CA (US); Brett Owen Ward, Carlsbad, CA (US)

(72) Inventors: Michael Dane Clark, San Diego, CA (US); Brett Owen Ward, Carlsbad, CA (US)

(21) Appl. No.: 13/430,976

(22) Filed: Mar. 27, 2012

(51) Int. Cl. A47G 25/14; B60R 9/00

(52) U.S. Cl. 224/482; 223/85

(57) ABSTRACT

A hanger for securing a garment or other item comprising two support bars that extend outward from connectors for removably attaching the hanger to a securing object, a hanger bar comprising a central section, a connecting section extending from one end of the central section, and a hanger bar projection extending from the other end of the central section, wherein the distal end of one support bar connects to the hanger bar at the end of the connecting section and the distal end of the second support bar connects to the hanger bar at a point on the central section.

### BACKGROUND OF THE INVENTION

1. Field of the Invention

The invention relates generally to the garment hangers. In particular, the invention relates to hangers for the secure storage or display of garments including wetsuits.

2. Description of Related Art

The prior art includes a wide range of garment hangers of various shapes and configurations. Many of these devices are designed to provide for secure storage and/or display of garments, particularly high-value garments. However, prior art devices have not adequately addressed the need for a hanger that can be used in a range of different settings, while securing the garment against theft without complex or expensive mechanical devices.

One particular situation where this is a problem involves the storage and drying of wetsuits used for various water sports including surfing, diving, water skiing, wakeboarding, etc. Wetsuits need to hang dry after each use, which presents a problem if they are used on the way to work or in any other situation where the wetsuit will be kept in a car for an extended period. Leaving a used wetsuit in a car prevents prompt drying of the suit and can cause odor buildup in the vehicle. No solution has been developed that allows the user to securely dry their wetsuit outside of their vehicle while parked in a public location.

The present invention provides a hanger that can be used in a wide range of settings to quickly and easily secure a garment for display or for storage. It is particularly suitable for secure public storage of garments such as wetsuits, that need to be arranged to allow them to air dry.

### SUMMARY OF THE INVENTION

A hanger comprising two support bars that extend outward from connectors for removably attaching the hanger to a securing object, a hanger bar comprising a central section, a connecting section extending from one end of the central section, and a hanger bar projection extending from the other end of the central section, wherein the distal end of one support bar connects to the hanger bar at the end of the connecting section and the distal end of the second support bar connects to the hanger bar at a point on the central section. In an exemplary embodiment of the invention, each connector comprises a slot configured to accept the top edge of an automobile window. In another exemplary embodiment of the invention, each connector comprises a flange configured to slide into a groove in the automobile door frame designed to receive the top edge of the automobile window.

In an exemplary embodiment, the central section of the hanger bar is generally horizontal. In an exemplary embodiment, the connecting section of the hanger bar extends in a downward slope from one end of the generally horizontal central section. In an exemplary embodiment, the hanger bar projection extends in a downward slope from the other end of the generally horizontal central section.

In various exemplary embodiments, each connector comprises a mechanism that locks the connector to the securing object such a combination lock, a key lock or a biometric lock.

### BRIEF DESCRIPTION OF THE DRAWINGS

FIG. 1 is a diagram showing a side perspective view of an exemplary embodiment of a hanger in accordance with the invention disclosed herein secured to the top edge of a window of a car with the window slightly open.

FIG. 2 is a diagram showing a front perspective view of an exemplary embodiment of a hanger in accordance with the invention disclosed herein secured to the top edge of a window of a car with the window closed.

FIG. 3 is a diagram showing a top perspective view of an exemplary embodiment of a hanger in accordance with the invention disclosed herein.

FIG. 4 is a diagram showing a side perspective view of an exemplary embodiment of a hanger in accordance with the invention disclosed herein with a wetsuit hanging on it.

### DETAILED DESCRIPTION OF THE PREFERRED EMBODIMENTS

The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the embodiments will be readily apparent to those skilled in the art, and general principles defined herein may be applied to other embodiments and applications without departing from the spirit and scope of the invention. Moreover, in the present disclosure, various devices are described and set forth with regard to several embodiments. It is contemplated that features of the disclosed embodiments may be combined in any manner as may be desired for various applications and implementations.

Thus, the present invention is not intended to be limited to the embodiments shown, but is to be accorded the widest possible scope consistent with the principles and features disclosed herein. Moreover, while the present invention is discussed herein with respect to a secure hanger that is particularly suitable for a wetsuit, it will be understood that the present invention can be used to securely hang any type of garment in any type of setting.

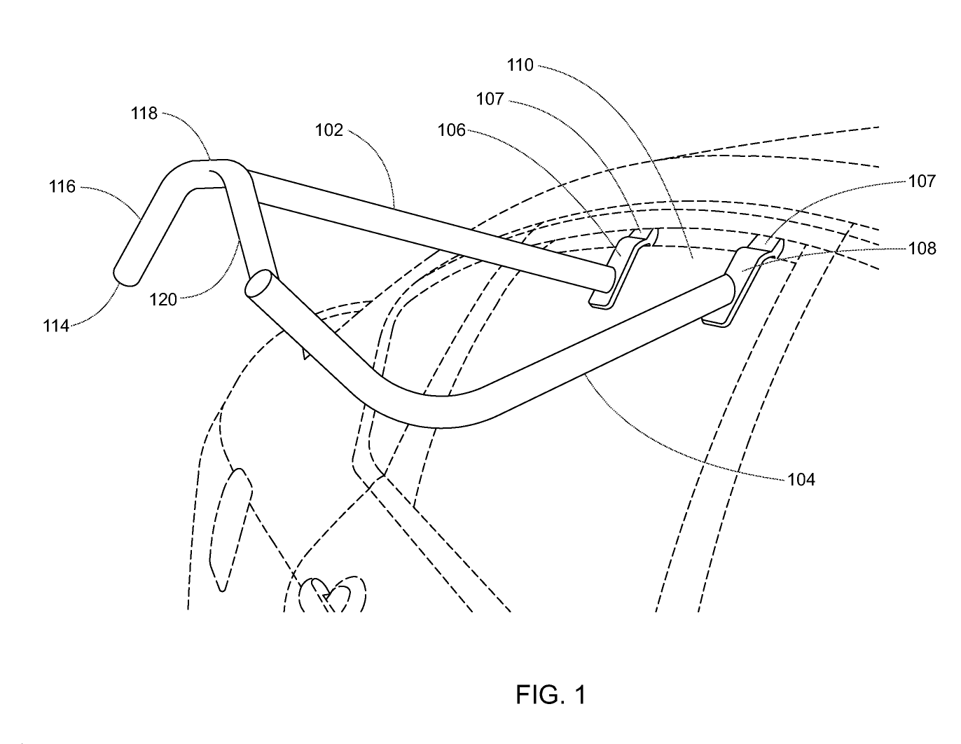

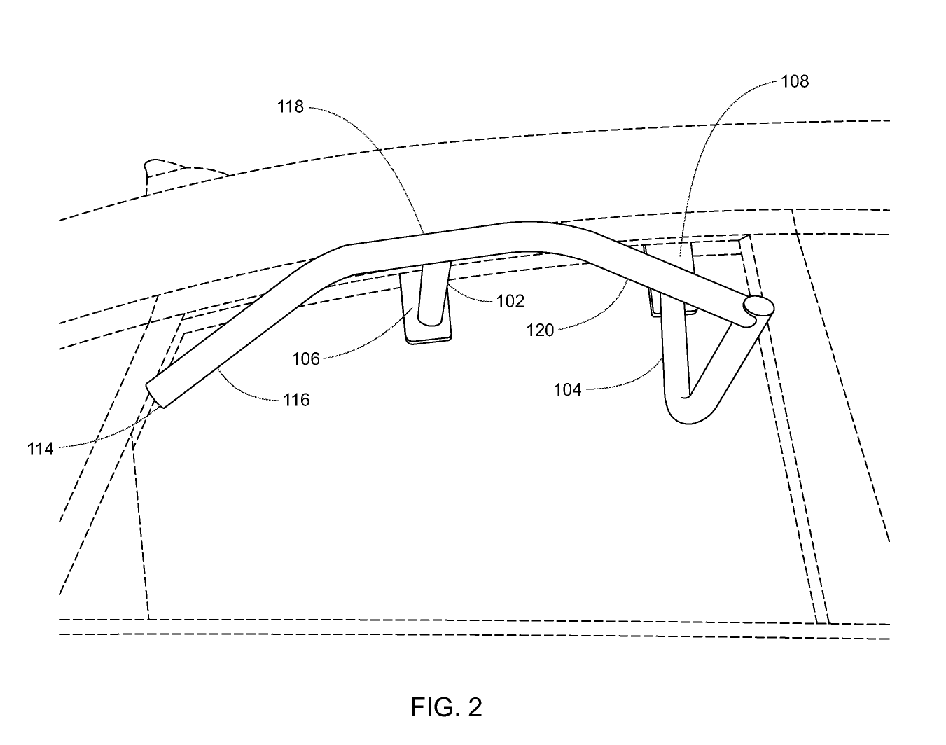

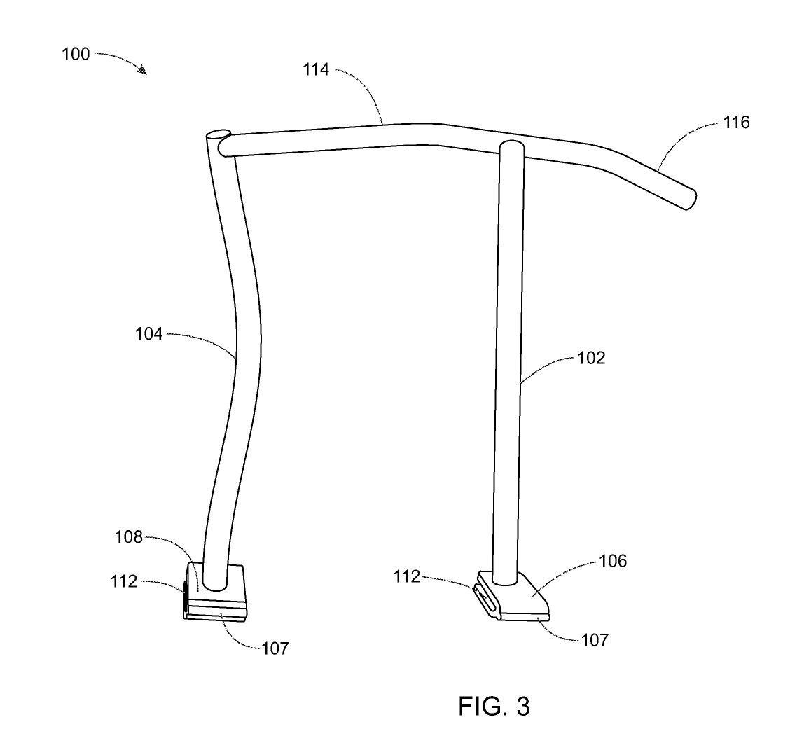

Referring to FIGS. 1 through 4, an exemplary embodiment of the invention comprises a hanger 100 comprising two support bars 102 and 104 that extend outward from connectors 106 and 108 respectively. Connectors 106 and 108 removably attach the hanger 100 to a securing object 110. As shown in FIGS. 1 through 4, in an exemplary embodiment of the invention the securing object 110 is the window of a car. In such an exemplary embodiment, each connector 106 and 108 comprises a slot 112 that is configured to accept the top edge of a car window, allowing the hanger 100 to be removably attached to the top edge of a car window. In an exemplary embodiment, connectors 106 and 108 also have a thin flange 107 that extends upward from the top of the connector and slips into the car door frame in the groove that accepts the top edge of the window.

In an exemplary embodiment, support bars 102 and 104 are connected together by hanger bar 114, such that one support bar 104 connects to hanger bar 114 at one end of hanger bar 114. The other support bar 102 connects to hanger bar 114 at a point such that hanger bar projection 116 extends further beyond the connection point with support bar 102. In an exemplary embodiment, hanger bar 114 comprises a generally horizontal central section 118 and a downward sloping connecting section 120 that connects to support bar 104, while hanger bar projection 116 slopes downward at an angle generally equal to the angle of downward sloping connecting section 120 at the opposite end of horizontal section 118. In other exemplary embodiments, the connecting section 120 and hangar bar projection 116 may be horizontal or extend from central section 118 at any angle suitable for the particular item to be hung.

Together, central section 118, connecting section 120 and hanger bar projection 116 may be configured to form a typical “hanger” shape that provides support for a garment 122 such that downward sloping connecting section 120 and hanger bar projection 116 begin near the point where the arms 124, 126 extend outward from the body 128 of the garment 122. First support bar 102 extends generally straight out from connector 106, while the other support bar 104 first extends downward from connector 108 at an angle then extends generally straight out to the point where it connects with one end of hanger bar 114. In various exemplary embodiments, the hanger bar 114 may be horizontal across its entire length, or may have a different shape to accommodate a different shape of article to be dried.

In use, hanger 100 is disconnected from securing object 110 and support bar 104 is inserted through the neck area of the garment 122 and through first sleeve 124 of the garment until connector 108 extends out through the sleeve 124 and support bar 102 is generally centered within the neck area of the garment. Hanger bar projection 116 is then inserted through the neck area of the garment 122 and down the other sleeve 126, so that the garment hangs correctly on the hanger bar 114. The hanger 100 is then connected to securing object 110 via connectors 106 and 108 to store or display the garment 122.

Once hanger 100 is connected to securing object 110 at both connectors 106 and 108, garment 122 cannot be removed from hanger 100. Garment 122 can only be removed without damage by disconnecting connectors 106 and 108. In various exemplary embodiments, connectors 106 and 108 are securely connected to securing object 110 such that they cannot be disconnected from securing object 110 except by authorized persons.

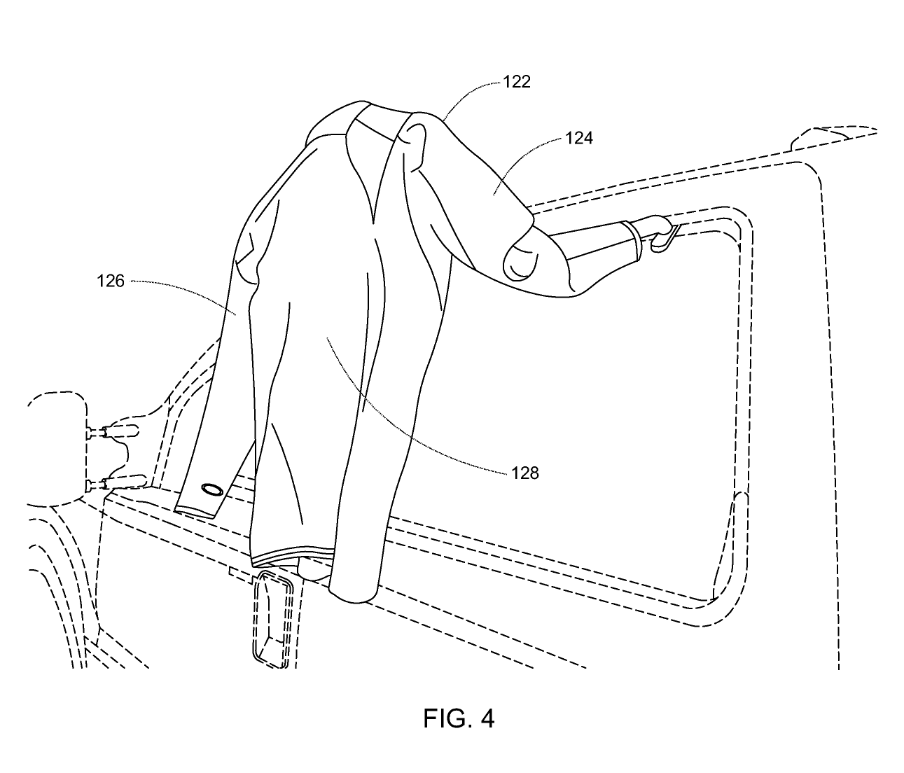

Referring to FIGS. 1, 2 and 4, in an exemplary embodiment, hanger 100 can be secured to the window of a vehicle such as a car. As shown in FIG. 4, such an embodiment is particularly useful for use in drying a wetsuit such as may be used for water sports, such as surfing, swimming, or scuba diving. The user can hang the wetsuit then secure the hanger 100 to the top edge of one of the car windows. When the window is closed, the hanger 100 is securely attached to the car and the wetsuit cannot be removed. This allows the user to hang dry their wetsuit in public parking areas, including office parking lots or other locations. A simple rack comprising a bar of the same width as the top edge of a car window can then be mounted to a wall and used to secure the same hanger 100 to hang the wetsuit at home.

It will be readily understood that while the present invention is disclosed with connectors designed to be removably attached to a car window, a wide range of connectors can be used to address particular needs. For example, the present invention could be used with locking connectors to securely display garments in a retail or trade show setting using connectors with any attachment mechanism that can securely affix support bars 102, 104 to a securing object such as a wall, post, vehicle, show booth, or display rack. The attachment mechanisms can take almost any form, including without limitation locking hooks, bolts, track and slide systems, or any other mechanism that can securely affix the support bars to a securing object and can be locked by any type of lock mechanism including combination, key, and biometric locks.

What is claimed is:

1. A hanger comprising:
two support bars that extend outward from connectors for removably attaching the hanger to a securing object;
a hanger bar comprising a central section, a connecting section extending from one end of the central section, and a hanger bar projection extending from the other end of the central section;
wherein the distal end of one support bar connects to the hanger bar at the end of the connecting section and the distal end of the second support bar connects to the hanger bar at a point on the central section.

2. The device of claim 1, wherein each connector comprises a slot configured to accept the top edge of an automobile window.

3. The device of claim 2, wherein each connector comprises a flange configured to slide into a groove in the automobile door frame designed to receive the top edge of the automobile window.

4. The device of claim 1, wherein the central section of the hanger bar is generally horizontal.

5. The device of claim 4, wherein the connecting section of the hanger bar extends in a downward slope from one end of the generally horizontal central section.

6. The device of claim 5, wherein the hanger bar projection extends in a downward slope from the other end of the generally horizontal central section.

7. The device of claim 1, wherein each connector comprises a mechanism that locks the connector to the securing object.

8. The device of claim 7, wherein the mechanism that locks the connector to the securing object is a combination lock.

9. The device of claim 7, wherein the mechanism that locks the connector to the securing object is a key lock.

10. The device of claim 7, wherein the mechanism that locks the connector to the securing object is a biometric lock.
